(19) United States
(12) Patent Application Publication
(10) Pub. No.: US 2024/0136591 A1
(43) Pub. Date: Apr. 25, 2024

(54) ELECTRODE AND SEPARATOR STACKING MACHINES FOR HIGH-SPEED BATTERY PRODUCTION

(71) Applicant: DWFritz Automation, LLC, Wilsonville, OR (US)

(72) Inventors: Derek Graham AQUI, Wilsonville, OR (US); Christopher E. BARNS, Wilsonville, OR (US); Scott G. BEARD, Wilsonville, OR (US); Joseba BRIT ELOLA, Wilsonville, OR (US); Brady L. BYERS, Wilsonville, OR (US); Gautam DHAR, Wilsonville, OR (US); Michael E. MYERS, Wilsonville, OR (US); William L. SCHULDT, Wilsonville, OR (US); Karl WEIBEZAHN, Wilsonville, OR (US); Alan J. SWAN, Wilsonville, OR (US)

(21) Appl. No.: 18/381,772

(22) Filed: Oct. 18, 2023

Related U.S. Application Data
(60) Provisional application No. 63/380,359, filed on Oct. 20, 2022.

(51) Int. Cl. H01M 10/0583

(52) U.S. Cl. CPC H01M 10/0583

(57) ABSTRACT

Disclosed are embodiments of battery stacker machines, including z-fold stacker machines, configured to provide a rolling transfer of a battery layer so as to reduce scrubbing. In some embodiments, the layer is flexed onto an arcuate surface using a vacuum or other force. The arcuate surface is then rotated to release the layer at a desired transfer location. For instance, the desired transfer location may be on top of a stack or onto another arcuate gripper surface.

### RELATED APPLICATION DATA

This application claims priority of U.S. Provisional Application No. 63/380,359, filed Oct. 20, 2022, which the entirety thereof is incorporated herein by reference.

### TECHNICAL FIELD

This disclosure generally relates to a battery stacker machine for stacking anodes, cathodes, and separator. The disclosure also relates to a method and a gripper for battery stacking. In particular, this disclosure relates to a rolling transfer of battery layers.

### BACKGROUND

Prismatic batteries are formed by interleaving alternate layers of cathodes, insulating separators, and anodes. Accordingly, to form a stack, the separator is a continuous layer that is folded back and forth (z-fold) between the alternating anode and cathode layers. The battery design itself precludes aligning the edges of individual layers to a common datum. To avoid malfunction, there should be no electrical contact between an anode and an adjacent cathode. To that end, the anode and cathode are typically mismatched in size and center aligned to each other, such that a physical border of 1 to 2 mm exists between adjacent anode and cathode layers.

Conventional z-fold stacker mechanisms are limited in throughput by system architectures following a repeating place/clamp/fold sequence. With one transfer device per each electrode, these previous attempts included various clamping and retention techniques to hold the stack in place while another electrode is placed on top, which reduces throughput. Moreover, synchronization for each transfer device and a separator feed device has been challenging.

One example of a previous attempt is described in Patent Application Publication No. US2006/0051652 A1 of Samuels. The '652 publication describes an interleave machine to form a stack. FIG. 1 of Samuels shows a first pick up and place device for handling a stack of cathodes, a second pick up and place device for handling a stack of anodes, and a centrally located elevator for interleaving a separator between alternating anode and cathode layers. In one embodiment, Samuels describes a Bernoulli pick up and place device for handling the electrodes. A carriage facilitates horizontal movement of the pick up and place devices.

Another example is Korean Patent No. 101220981, which also describes a stacking device having a first vacuum transfer means for anodes and a second vacuum transfer means for cathodes. Each vacuum transfer means can pivot to fold the separator down onto the stack.

### SUMMARY

In one aspect, a method, performed by a battery stacker or by a gripper of a battery stacker, is disclosed for forming a battery electrode and separator stack. The method comprises applying, via an arcuate surface, a force to a battery layer to move it from a first location and flex it into a conforming position on the arcuate surface. The method further comprises, while the force maintains the battery layer flexed in the conforming position, rotating the arcuate surface with the battery layer into a second location. The method further comprises transferring the battery layer from the conforming position on the arcuate surface to a receiver surface, wherein the transferring comprises releasing the force applied via the arcuate surface.

In some embodiments, the receiver surface is another arcuate surface, and wherein the transferring comprises applying a force with the arcuate receiver surface to flex the layer into a conforming position on the receiver surface.

In some embodiments, the receiver surface is a battery electrode and separator stack comprising a substantially planar surface, and wherein the transferring comprises transferring the battery stack to an unflexed position.

The method may also include eccentrically rotating the arcuate surface so that it translates laterally and vertically relative to the receiver surface.

The method may also include applying the force by pulling a vacuum through apertures in the arcuate surface.

The method may also include the battery layer having a discrete electrode atop a continuous separator sheet.

The method may also include the battery layer having a discrete electrode atop a discrete separator sheet.

The method may also include applying the force by pulling a vacuum through apertures in a laterally reciprocating gripper.

The method may also include gradually applying, as a function of lateral position, positive pressure through apertures in the arcuate surface.

The method may also include the first location being a vertically oriented material-transfer position defined by the arcuate surface confronting another arcuate surface that acts as a pick-and-place device.

The method may also include performing the applying of the force, the rotating, and the transferring in connection with a first laterally reciprocating roller on a first side of the battery stacker, and the method further includes repeating the applying of the force, the rotating, and the transferring in connection with a second laterally reciprocating roller on a second side of the battery stacker.

The method may also include the applying of the force by pulling a vacuum through pores on the continuous separator sheet to flex the battery layer.

In one aspect, a battery stacker is disclosed. The stacker includes an arcuate surface configured for application of a force for pulling a battery layer from a first location and flexing into a conforming position on the arcuate surface, an axis about which the arcuate surface is rotatable while the force maintains the battery layer flexed in the conforming position so as to rotate the battery layer into a second location, and a receiver surface for receiving the battery layer in response to release of the force to transfer the battery layer from the conforming position on the arcuate surface to the receiver surface.

In some embodiments, the receiver surface may be another arcuate surface of a battery stacker, which may comprise means for applying a force on the battery layer. In some embodiments, the receiver surface may be identical or substantially identical to the arcuate surface from which the battery layer is transferred. In some embodiments, the receiver surface is a battery electrode and separator stack comprising a substantially planar surface.

The battery stacker may also include a rotatable multi-sided gripper including the arcuate surface. The rotatable multi-sided gripper may be eccentrically rotatable.

The battery stacker may also include left- and right-side eccentrically rotatable multi-sided grippers acting as pick-and-place devices.

The battery stacker may also be a z-fold stacker.

The battery stacker may also include the force as a vacuum force applied through apertures in the arcuate surface.

The battery stacker may also include the force being a first force and in which the arcuate surface is configured for application of a second force as a positive pressure applied though apertures in the arcuate surface.

In one aspect, a rotatable multi-sided gripper for transporting a battery layer is disclosed. The gripper comprises a body, including three mutually angularly spaced apparat arcuate gripper surfaces, and three mutually angularly spaced apparat truncated sides. Each arcuate gripper surface comprises means for applying a force on a battery layer positioned on the gripper surface for maintaining the battery layer in a conforming position on the arcuate surface.

In some embodiments, each arcuate gripper surface further comprises means for applying a second force as a positive pressure on the battery layer in order to release and/or transfer the battery layer to a receiver surface.

The disclosed embodiments exploit the physical flexibility of the materials to be stacked to perform material handoffs by means of a rolling action. There are four cases of rolling handoffs that may leverage the disclosed techniques: (1) transfer from a moving roller to a stationary plane; (2) transfer from a stationary plane to a moving roller; (3) transfer from a stationary roller to a moving plane; or (4) transfer from a moving plane to a stationary roller. The disclosed material transfer is made with no scrubbing, i.e., minimal relative motion between the roller and the plane.

Conventional z-fold stacker techniques typically use reciprocating motion (e.g., pick and place) to build a stack from discrete electrodes. Thus, in some embodiments, it is also desirable to use continuous rotary motion as an alternative to reciprocation.

Additional aspects and advantages will be apparent from the following detailed description of embodiments, which proceeds with reference to the accompanying drawings.

### BRIEF DESCRIPTION OF THE DRAWINGS

To easily identify the discussion of any particular element or act, the most significant digit or digits in a reference number refer to the figure number in which that element is first introduced.

FIG. 1 is an isometric view of a z-fold stacker machine, according to one embodiment.

FIG. 2 is a sequence of side elevation views showing a sequence of different transverse material-transfer positions as a multi-sided gripper of FIG. 1 rotates counterclockwise and eccentrically, according to one embodiment.

FIG. 3 is an isometric view of an eccentrically rotatable multi-sided gripper assembly, according to one embodiment.

FIG. 4 is an isometric view of a z-fold stacker machine having separate stacks for each type of electrode, according to one embodiment.

FIG. 5 is a set of detail views of the z-fold stacker machine of FIG. 4 during a stacking sequence.

FIG. 6 is an isometric view of a z-fold stacker machine, according to another embodiment.

FIG. 7 is a side elevation view of a Reuleaux triangle, according to one embodiment.

FIG. 8 is a graph showing scrubbing as the function of the angular position of the Reuleaux triangle shown in FIG. 7.

FIG. 9 is a side elevation view of a centroid for the Reuleaux triangle shown in FIG. 7.

FIG. 10 is an annotated side elevation view of a portion of centroid circular and non-circular orbital paths, according to one embodiment.

FIG. 11 is a side elevation view showing an entire view of the centroid circular orbital path of FIG. 10 inscribed in the centroid non-circular orbital path of FIG. 9 and FIG. 10.

FIG. 12 is a side elevation view of the Reuleaux triangle of FIG. 7 annotated with angular position lines for empirically determining an arcuate surface that has no scrubbing and has the centroid circular orbital path shown in FIG. 11.

FIG. 13 is a side elevation view showing in greater detail the position lines of FIG. 12.

FIG. 14 is a side elevation view showing in greater detail intersections of position lines shown in FIG. 12 and FIG. 13.

FIG. 15 is a side elevation view showing in greater detail an angle formed at the intersections shown in FIG. 14.

FIG. 16 is a side elevation view showing a modified arcuate surface empirically derived using the techniques shown in FIG. 9-FIG. 15.

FIG. 17 is an isometric view showing a modified arcuate surface of FIG. 16 deployed on three mutually angularly spaced apart sides.

FIG. 18 is an isometric view of a z-fold stacker machine, according to another embodiment having a reciprocating carriage.

FIG. 19 is a set of isometric views showing the reciprocating carriage and vacuum rollers in a sequence of stacking positions, according to one embodiment.

FIG. 20 is a set of side elevation views showing the vacuum rollers of FIG. 19 in a sequence of stacking positions, according to one embodiment.

FIG. 21 is a set of isometric views showing a z-fold stacker machine during a stacking sequence, according to another embodiment.

FIG. 22 is a flow diagram of a process, in accordance with one embodiment.

FIG. 23 is a flow diagram of a process in accordance with another embodiment.

### DETAILED DESCRIPTION

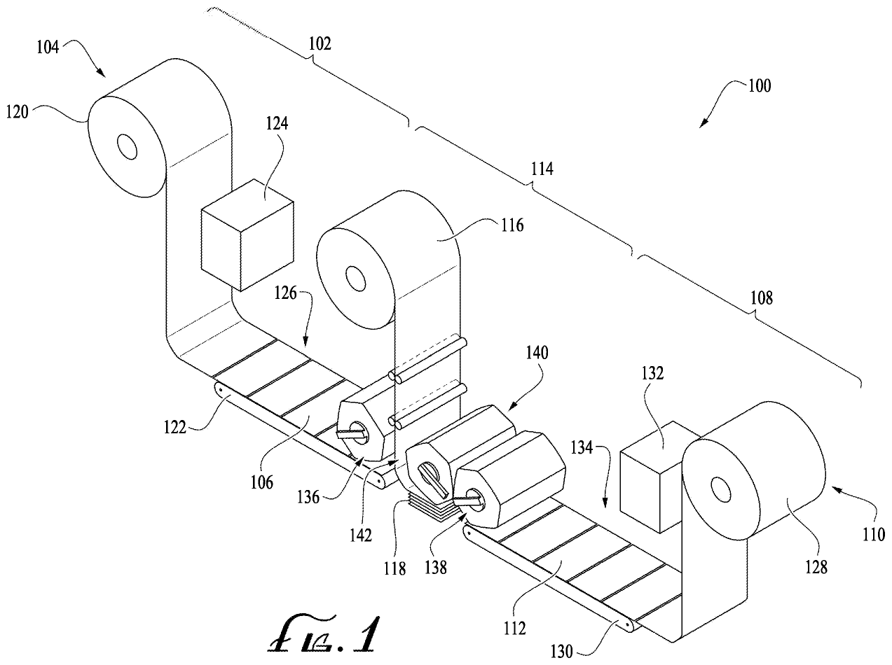

FIG. 1 shows a simplified view of a z-fold stacker machine 100, according to one embodiment. Z-fold stacker machine 100 includes a first electrode delivery system 102 for providing a first type of electrode material 104 (e.g., a copper anode 106), a second electrode delivery system 108 providing a second type of electrode material 110 (e.g., an aluminum cathode 112), and a central assembly system 114 providing a separator 116 for z-folding with the electrodes to form a battery stack 118. In a z-fold configuration, separator 116 is not singulated into discrete layers but instead forms a single continuous layer that is folded back and forth between alternating electrodes (anodes and cathodes).

In battery stack 118, copper anode 106 and aluminum cathode 112 are typically mismatched in size and center aligned to each other (i.e., with no common edge datum), such that a physical border of 1 to 2 mm exists between adjacent anode and cathode layers. Z-fold stacker machine 100 is designed to meet this center alignment specification, typically to an accuracy of about 0.25 mm. Z-fold stacker machine 100 can accommodate a wide range of electrode sizes.

In the example of z-fold stacker machine 100, first electrode delivery system 102 includes a first roll 120 of electrode material 104. As electrode material 104 is pulled from first roll 120 by a conveyor 122 or other transport mechanism, a laser ablation device 124 cuts electrode material 104 to form first electrodes 126 that are singulated from first roll 120.

Likewise, second electrode delivery system 108 includes a second roll 128 of electrode material 110. As electrode material 110 is pulled from second roll 128 by a conveyor 130 or other transport mechanism, a laser ablation device 132 cuts electrode material 110 to form second electrodes 134 that are singulated from second roll 128.

Central assembly system 114 includes three eccentrically rotatable multi-sided grippers, which are explained in further detail below. Initially, however, each eccentrically rotatable multi-sided gripper has a longitudinal axis that is offset from an axis of rotation such that the eccentrically rotatable multi-sided gripper moves about a circular path while sequentially presenting different arcuate gripper surfaces to transverse material-transfer positions.

In this example of z-fold stacker machine 100, a first eccentrically rotatable multi-sided gripper 136 and a second eccentrically rotatable multi-sided gripper 138 act as pick-and-place devices that move electrodes from horizontal positions atop respective conveyor 122 and conveyor 130 to vertical positions where they are transferrable to a central eccentrically rotatable multi-sided gripper 140 that also selectively engages a draped section 142 of separator 116. Central eccentrically rotatable multi-sided gripper 140 then places the material atop battery stack 118.

In this embodiment, separator 116 is fed along the same side as first electrodes 126, but at twice the rate, i.e., twice the length of separator per length of electrode. The unconstrained portion of the separator (between battery stack 118 and the electrode being picked) is held in tension by air pressure before it is folded onto battery stack 118 by orbital motion of central eccentrically rotatable multi-sided gripper 140. The inherent flexibility of the materials enables picking and placing with a rolling action at predetermined locations while central eccentrically rotatable multi-sided gripper 140 maintains continuous orbital motion. Because central assembly system 114 employs continuous rotary motion, z-fold stacker machine 100 is capable of high throughput, high efficiency, and reduction of the high forces and vibrations associated with reciprocating motion.

As explained below, loading of layers from arcuate gripper surfaces and unloading them onto battery stack 118 is achieved with substantially no scrubbing. Scrubbing occurs when one layer at the top of a stack is pulled laterally (i.e., dragged or slipped) against a lower layer. For instance, in some embodiments, there is less than about 100 μm in terms of a change in distance from an initial point of contact of two layers to the final relative position of the layers. Skilled persons will appreciate, however, that different tolerances for scrubbing may be achieved using different battery layer materials and production specifications.

The continuous motion of the rotational components at a constant rotational velocity enables higher throughput. A targeted cycle time of 0.1 s (electrode to electrode) is about six times faster than a conventional system. This means that a stack of a typical quantity of 100 layers can be completed in 10 seconds instead of 60 seconds.

In some embodiments, to maintain the overall throughput of the factory, a completed stack assembly is rapidly removed and replaced by and identical stack elevator assembly by means of a linear shuttle transverse to the feed direction. This optional shuttle maximizes the utilization of the stacking process. Downstream process steps (e.g., wrapping, taping, and other steps) can then be done in parallel with building the subsequent stack.

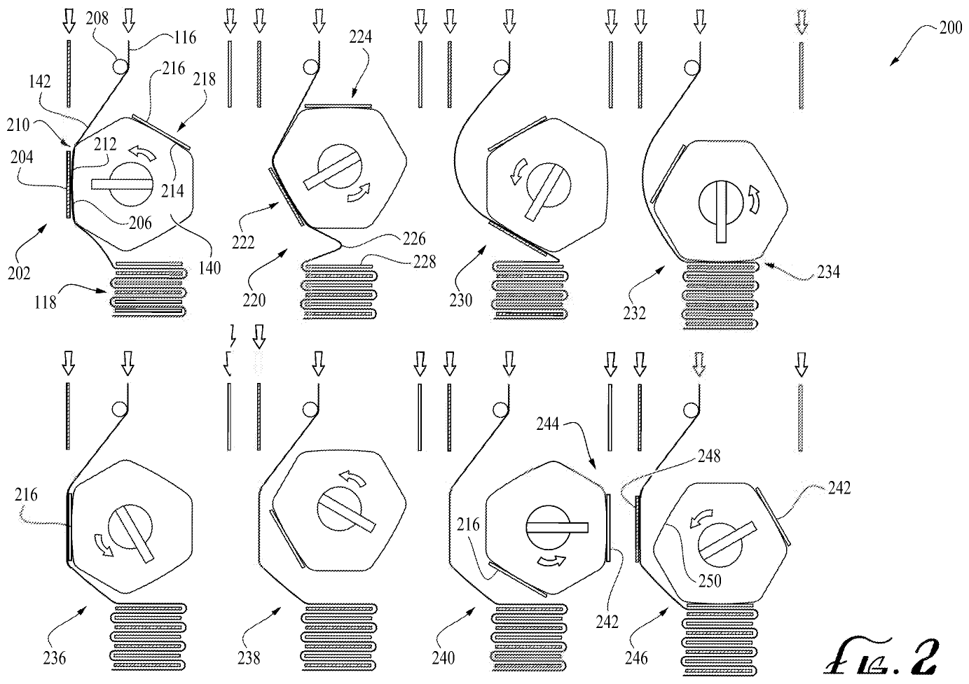

FIG. 2 shows in greater detail a sequence of different transverse material-transfer positions 200 as central eccentrically rotatable multi-sided gripper 140 rotates counterclockwise while also moving eccentrically. Each position in sequence of different transverse material-transfer positions 200 is explained in detail below.

Initially, in the example of FIG. 2, first eccentrically rotatable multi-sided gripper 136 and second eccentrically rotatable multi-sided gripper 138 are omitted for conciseness. Also, the movements of first electrodes 126 and second electrodes 134 are simplified so that they are shown as being lowered vertically to meet arcuate gripper surfaces of central eccentrically rotatable multi-sided gripper 140. In view of z-fold stacker machine 100, however, skilled persons should appreciate that electrodes of z-fold stacker machine 100 are moved from horizontal orientations to vertical orientations as first eccentrically rotatable multi-sided gripper 136 rotates counterclockwise and eccentrically, and as second eccentrically rotatable multi-sided gripper 138 rotates clockwise and eccentrically.

A first position 202 is established when first eccentrically rotatable multi-sided gripper 136 (FIG. 1), as it rotates, sequentially presents its three arcuate gripper surfaces to the top of conveyor 122 (FIG. 1) that transports a first electrode 204 to a position under a confronting one of the arcuate gripper surfaces of first eccentrically rotatable multi-sided gripper 136. First electrode 204 is then picked up (e.g., using vacuum pressure or electrostatic attraction) as the arcuate gripper surface rotates upward (i.e., counterclockwise) while it eccentrically moves toward draped section 142 of separator 116.

Concurrently, central eccentrically rotatable multi-sided gripper 140 has a first arcuate gripper surface 206 rotated downward and eccentrically moved toward draped section 142 as an idler roller 208 is adjusted to maintain tension on separator 116. As the two confronting arcuate gripper surfaces meet at a left-side material-transfer position 210, first electrode 204 is released from first eccentrically rotatable multi-sided gripper 136 and simultaneously pulled onto central eccentrically rotatable multi-sided gripper 140 (e.g., it vacuumed through the relatively porous draped section 142 underlying first electrode 204). Thus, first arcuate gripper surface 206 retains first electrode 204 and a secured portion 212 of separator 116. Also, a second arcuate gripper surface 214 holds a second electrode 216 in an upward intermediate right-side position 218 oriented 120° clockwise from left-side material-transfer position 210.

With first electrode 204 and secured portion 212 held by central eccentrically rotatable multi-sided gripper 140, a second position 220 is established as central eccentrically rotatable multi-sided gripper 140 continues to rotate downward and eccentrically toward battery stack 118. Accordingly, first electrode 204 and secured portion 212 pass through an intermediate left-side position 222, and second electrode 216 arrives at a top-most central position 224. A jet of air from an air knife, vacuum, or similar force is applied to a slack section 226 of separator 116 to direct it across a top 228 of battery stack 118, thereby imparting a z-fold bend in slack section 226 preparatory to placing first electrode 204 atop battery stack 118.

As central eccentrically rotatable multi-sided gripper 140 continues to rotate to a third position 230, first electrode 204 and secured portion 212 move further downward and rightward. Second electrode 216 moves closer to left-side material-transfer position 210.

In a fourth position 232, central eccentrically rotatable multi-sided gripper 140 is at a bottom-most central position 234 at which point first electrode 204 and secured portion 212 are released on top 228 of battery stack 118. A z-elevator (not shown) for battery stack 118 decrements downward as layers are added such that placement always occurs at the same elevation. As noted above, the release at bottom-most central position 234 is made with substantially no lateral movement so as to avoid scrubbing.

Once released, central eccentrically rotatable multi-sided gripper 140 continues rotating and moving toward second eccentrically rotatable multi-sided gripper 138 (FIG. 1). A fifth position 236 shows second electrodes 216 and second arcuate gripper surface 214 at left-side material-transfer position 210 for loading with substantially no scrubbing. Notably, second arcuate gripper surface 214 is not used to retain any portion of separator 116. In some embodiments, an air jet or vacuum pushes separator 116 away from second arcuate gripper surface 214, as shown in sixth position 238. This creates space for second electrode 216 to move toward top 228, as shown in seventh position 240. Seventh position 240 also shows how a third electrode 242 is attached to first arcuate gripper surface 206 at a right-side material-transfer position 244. Third electrode 242 is the same type of material as that of second electrode 216 (e.g., aluminum cathode 112, FIG. 1), both of which are provided by second eccentrically rotatable multi-sided gripper 138 (FIG. 1).

Finally, in an eighth position 246, second electrode 216 is released atop battery stack 118 without scrubbing. Third electrode 242 is rotated upward and eccentrically moved away from right-side material-transfer position 244, and a fourth electrode 248 (of the same type as first electrode 204) is moved into left-side material-transfer position 210 by first eccentrically rotatable multi-sided gripper 136 (FIG. 1) so that the process can repeat when a third arcuate gripper surface 250 reaches first position 202.

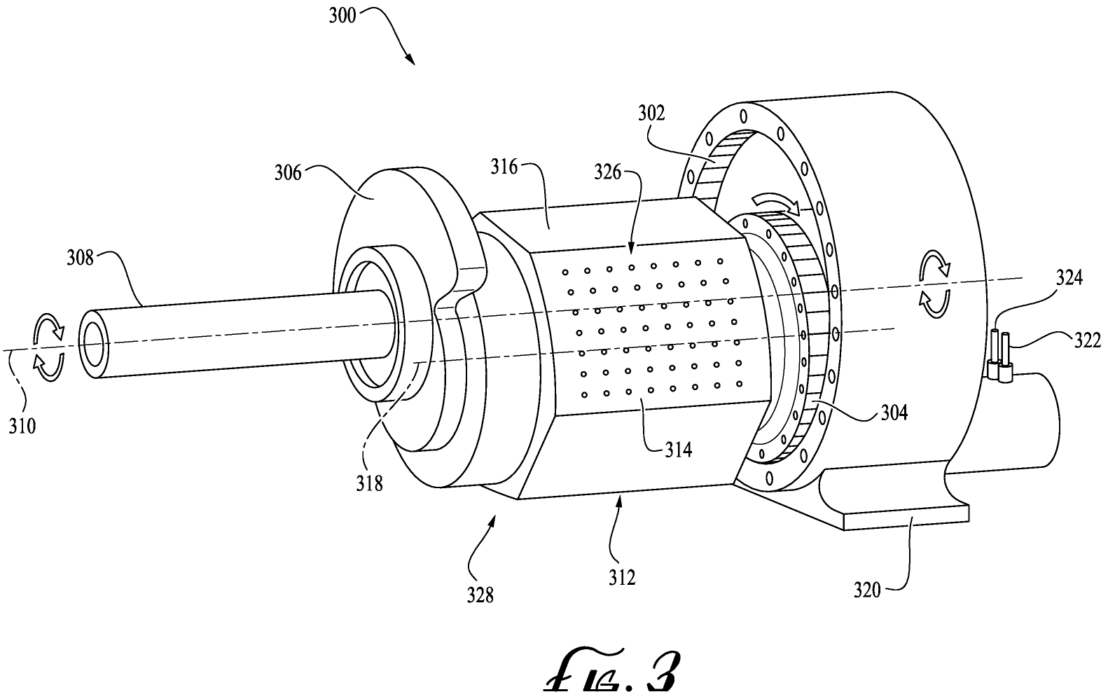

FIG. 3 shows an eccentrically rotatable multi-sided gripper assembly 300. Eccentrically rotatable multi-sided gripper assembly 300 includes an internal ring gear 302, an external planetary gear 304, a central eccentrically rotatable multi-sided gripper 140 (e.g., central eccentrically rotatable multi-sided gripper 140 of FIG. 1 and FIG. 2), a counterbalance 306, and an input shaft 308 establishing a pivot axis of rotation 310. In this example, central eccentrically rotatable multi-sided gripper 140 is a six-sided non-cylindrical body 312 that includes three mutually angularly spaced apart arcuate gripper surfaces 314 and three mutually angularly spaced apart truncated sides 316.

Body 312 has an offset longitudinal axis 318 that is spaced apart from pivot axis of rotation 310 to establish eccentric orbital motion that is guided by external planetary gear 304 in internal ring gear 302. A mounting block 320 houses internal ring gear 302 and provides a pneumatic inlet port 322 and a pneumatic outlet port 324.

Without truncated side 316, arcuate gripper surface 314 could form a three-sided body resembling a triangle with curved sides. In body 312, however, vertices of the triangle are truncated for clearance and reduced mass, since they perform no function related to stacking. The specific design of the truncated faces may be tailored to accommodate the tensioning on the unconstrained separator (i.e., tensioning on secured portion 212 and slack section 226 (FIG. 2)).

Arcuate gripper surfaces 314 include pneumatic gripper apertures 326 configured to apply vacuum and pressure (obtained from pneumatic inlet port 322 and pneumatic outlet port 324) to hold and release layers from two active arcuate gripper surfaces 314, as explained previously with reference to FIG. 2.

In some embodiments, continuous negative and positive pressures are applied to ports. Delivery of these pressures, however, is made periodically automatically as a function of orbital position through fluid communication channels (not shown) in body 312 that align with fixed internal port locations (not shown) as central eccentrically rotatable multi-sided gripper 140 orbits.

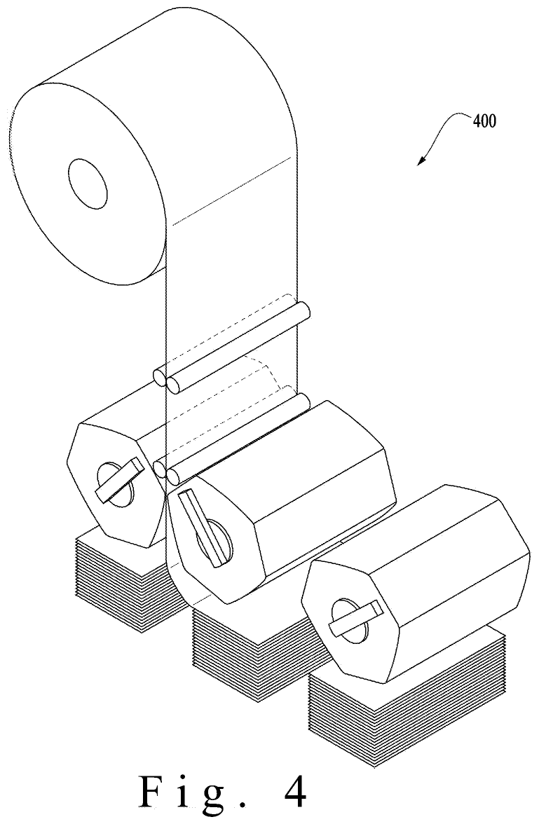

FIG. 4 shows a variant of a z-fold stacker machine 400 in which electrodes are provided in separate stacks, rather than by conveyor transport. In other embodiments, the separator may also be singulated (i.e., not z-folded).

To illustrate an example of retention and handoff forces applied during transfer of an electrode and separator section, FIG. 5 shows in greater detail z-fold stacker machine 400 during, respectively, eighth position 246, first position 202, and second position 220.

In eighth position 246, a first battery layer 502 (e.g., a graphite-coated copper or aluminum electrode) is flexed into a conforming position on a first arcuate gripper surface 504. The dashed arrow lines show the application of a vacuum force (negative pressure) that pulls first battery layer 502 onto first arcuate gripper surface 504. In this example, draped section 142 is not affected by the vacuum force, although in other embodiments draped section 142 may also be pulled toward first arcuate gripper surface 504 (see, e.g., fourth electrode 248 and the separator 116 in FIG. 2).

In first position 202, an upper portion 506 of first arcuate gripper surface 504 applies a negative pressure while a bottom portion 508 applies a positive pressure (indicated by solid arrow lines). Concurrently, an upper portion 510 of a second arcuate gripper surface 512 applies no pressure and a bottom portion 514 applies negative pressure. Thus, central eccentrically rotatable multi-sided gripper 140 applies, via its second arcuate gripper surface 512, the negative force to pull the battery layer from its left-side material-transfer position 210 on first arcuate gripper surface 504 and flex it into a conforming position on second arcuate gripper surface 512.

In second position 220, the coordination of pressures thereby transfers the material from one surface to the other surface. First arcuate gripper surface 504 applies only a positive pressure 516 and second arcuate gripper surface 512 applies only a negative pressure 518. Positive pressure 516 from first arcuate gripper surface 504 also acts to facilitate a z-fold 520 in slack section 226 (FIG. 2).

From second position 220, while the force of negative pressure 518 maintains the battery layer flexed in the conforming position, central eccentrically rotatable multi-sided gripper 140 rotates second arcuate gripper surface 512 with the battery layer into a second location (i.e., bottom-most central position 234, FIG. 2) that is transverse to left-side material-transfer position 210, at which point negative pressure 518 is released while applying an opposite force (not shown) to transfer the battery layer from the conforming position on second arcuate gripper surface 512 and into an unflexed position on a planar receiver surface (e.g., top 228 of battery stack 118). This provides a substantially scrub-free transfer of the battery layer from the conforming position on the arcuate surface and into an unflexed position on a receiver surface for depositing the battery layer into the battery electrode and separator stack.

Note that, in some embodiments, the opposite force (e.g., positive pressure) is optional. For instance, depending on the speed of rotation, releasing the force while rotating is sufficient for placing the electrode atop battery stack 118 because gravity is sufficient to separate the material from the arcuate surface.

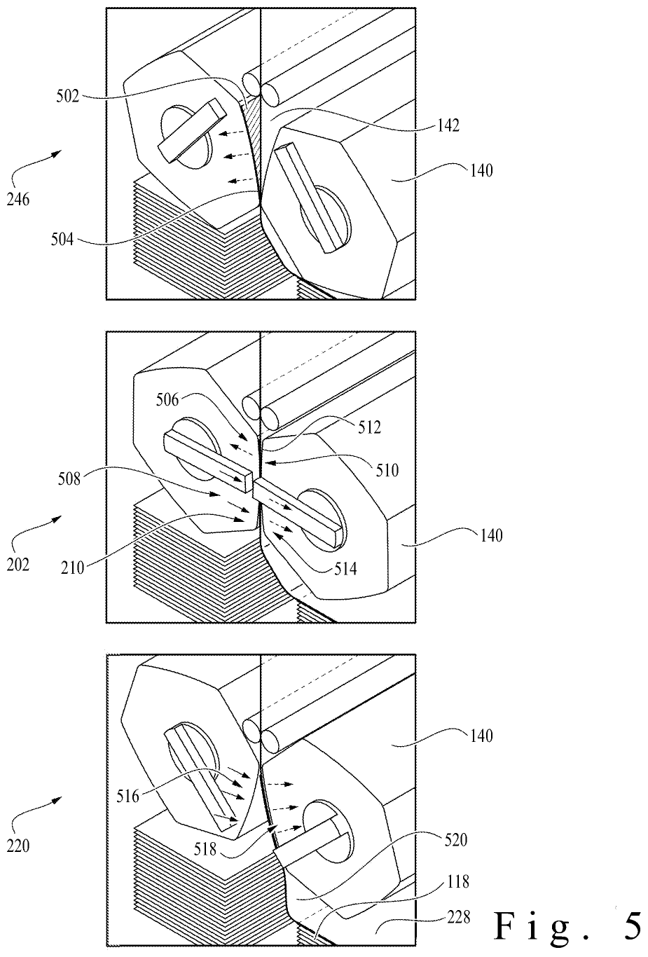

FIG. 6 shows a z-fold stacker machine 600, according to another embodiment. In this example, instead of first eccentrically rotatable multi-sided gripper 136 and second eccentrically rotatable multi-sided gripper 138, vacuum conveyors 602 are used to move electrodes into a vertical orientation for central eccentrically rotatable multi-sided gripper 140 to grip and place on the stack.

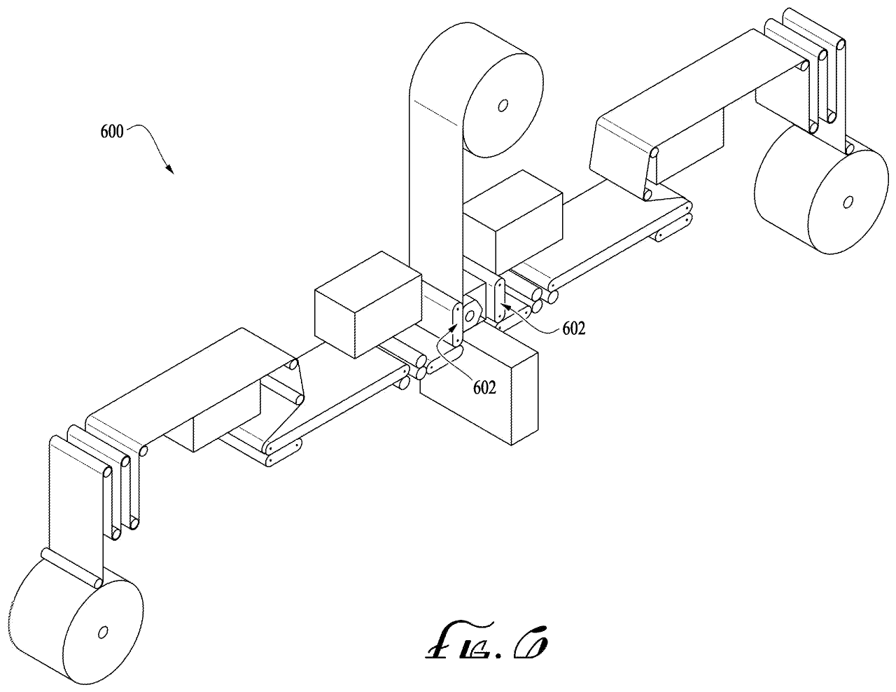

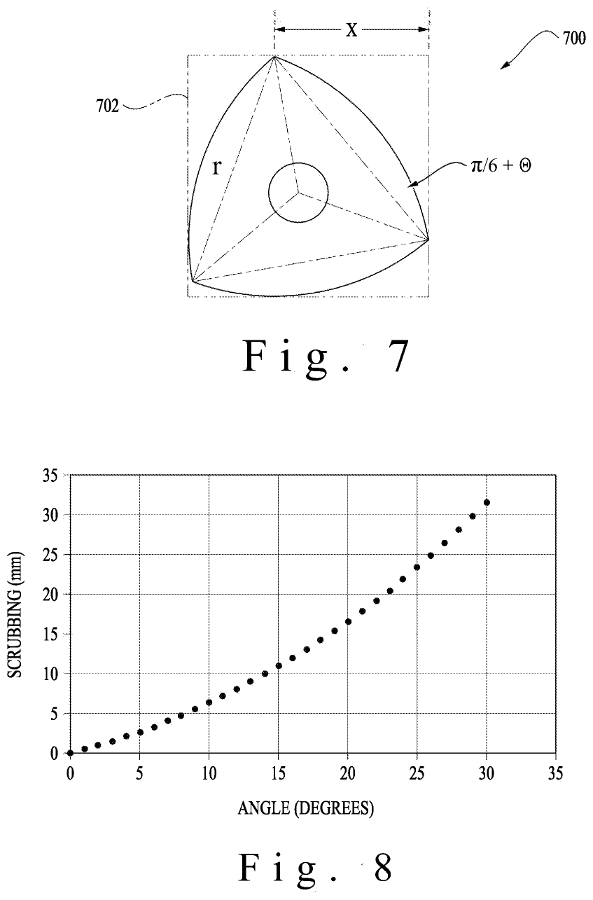

As mentioned previously, eccentrically rotatable multi-sided gripper 328 includes arcuate gripper surfaces 314 for continuous rotary motion. One candidate shape of the surfaces for the continuous rotary motion system is based on a Reuleaux triangle 700, as shown in FIG. 7. The boundary of Reuleaux triangle 700 is a constant width curve based on an equilateral triangle. All points on a side are equidistant from the opposite vertex. Reuleaux triangle 700 can form a rotor within a square, capable of a complete rotation while staying within the square and at all times touching all four sides of the square. In practice, the central portion of each curved face could roughly match the length (measured in the feed direction) of the electrode, enabling the gripper surfaces to accommodate a range of lengths (theoretically, up to r*π/3, where r is the length of a side of the equilateral triangle in Reuleaux triangle 700, which is also a radius of curvature of the curved face). In general, shorter electrode lengths enable higher throughput, but this is a function of the design of the electrode, i.e., specifically the placement of the terminal tab, which is located transverse to the feed direction.

Notably, however, there are two issues in a system based on a pure Reuleaux triangle. The first is that the orbital motion at the center of the triangle is not a simple circle, but combined segments of four ellipses. The second is that the action of the rotor on the electrodes at the sides of the square is not pure rolling that is free from scrubbing. For pure rolling, the linear distance travelled by the vertex along one side of the square must be equal to the length of the opposite arc as it is rolled along the opposite side. A difference results in scrubbing due to relative linear motion between the curved surface and the electrode to be picked or placed.

FIG. 7 and FIG. 8 show how the scrubbing can be quantified. Consider Reuleaux triangle 700 of side r continuously orbiting inside a square perimeter 702 also of side r. Electrodes are picked from the left and right sides of the square perimeter 702 and placed to a stack (not shown) at the bottom side of the square perimeter 702. For a general half angle Θ, where Θ varies between 0° (vertical contact in the middle of the stack) and 30° (π/6), then as Θ increases from 0°, the rotational (arc) distance travelled is r*Θ. The distance X is given by X =r sin(π/6+Θ)=r/2*(cos Θ+∛ sin Θ). Subtracting r/2 from X, then the linear distance travelled is r/2*(cos Θ+∛ sin Θ−1). The scrubbing is the difference between the two: r/2*(2Θ+1−cos Θ−∛ sin Θ).

FIG. 8 shows that, as a percentage of r, the scrubbing effect is substantial. Since the scrubbing can be characterized mathematically, it can be compensated for, but that would entail additional reciprocating motion of the two input locations and the output stack. Similarly, the complex ellipsoidal orbit of the rotor can be achieved through sophisticated motion control or cam design, but a pure rotary motion is preferred for its simplicity and reliability. Both of these effects are addressed in a modified Reuleaux triangle, explained below.

A first step in designing a modified Reuleaux triangle is to create a non-slip profile path for the centroid of the shape. The non-slip path would ensure pure rolling motion at the curved surface. This is accomplished by assuming that the rolling traversal distance equals the lateral motion of the Reuleaux triangle top vertex. This is similar to a non-slip wheel traversing a distance, with the specification being that the arc length contacting the ground during motion is equivalent to the axle lateral distance travelled.

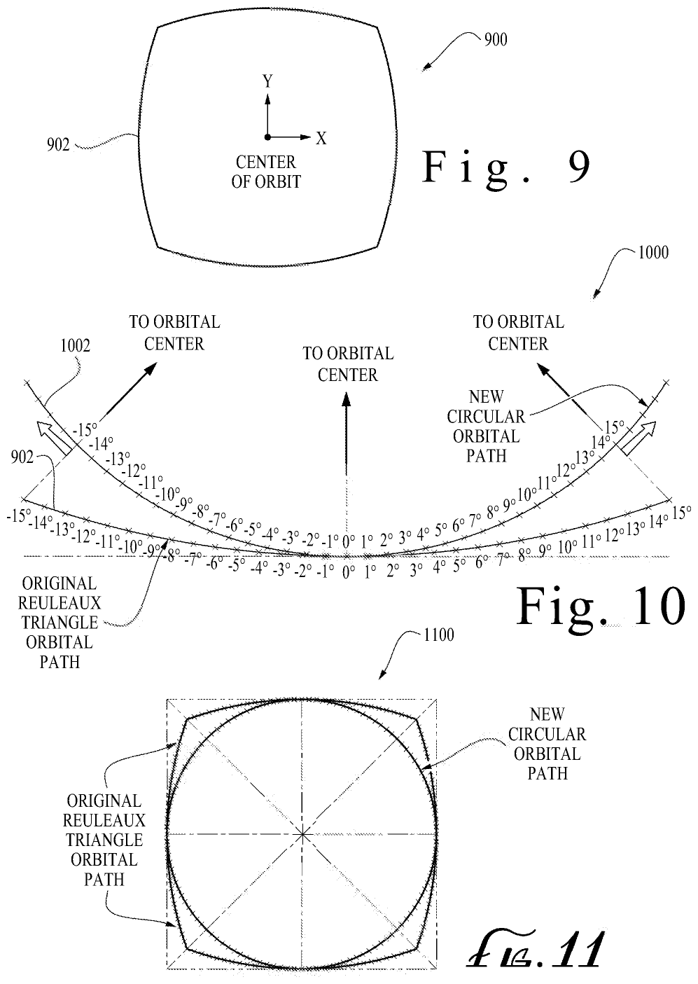

FIG. 9 shows how a non-circular centroid orbital path 900 in X and Y can then be represented as a function of theta: X=(r*Θ)−(r_{centroid}*sin(Θ)); Y=r_{centroid}*cos(Θ). Each of four arcuate paths 902 is the result of graphing non-circular centroid orbital path 900 for appropriate values of r and r_{centroid}. Note that for any given one of the four (square perimeter) sides defined by a Reuleaux triangle, Θ is defined from ±15° from its center location, which is the extent of the path before the adjacent curve of the triangle contacts the next orthogonal edge of the larger square. FIG. 9 shows that non-circular centroid orbital path 900 has sharp corners.

This is not amenable nor practical for motion using standard gear driven transmission assemblies.

Accordingly, FIG. 10-FIG. 17 show an example of an empirical way to smooth non-circular centroid orbital path 900 by inscribing a circular centroid orbital path 1000 (FIG. 10) as the orbit driven using an eccentric or planetary gear system, described previously.

In order to realize zero scrubbing, constant angular velocity gear motion, and proportional centroidal Θ counter-rotation during orbit, FIG. 10 shows that an arc length of arcuate path 1002 is directly proportional to the Reuleaux triangle rotation Θ angle. For simplicity, both paths 902 and 1002 are shown divided up into 1° increments of Θ. The total Θ span is 30° (±15°), which corresponds to the total rolling contact range on one side of the outer square before contact is made on an adjacent side of the square.

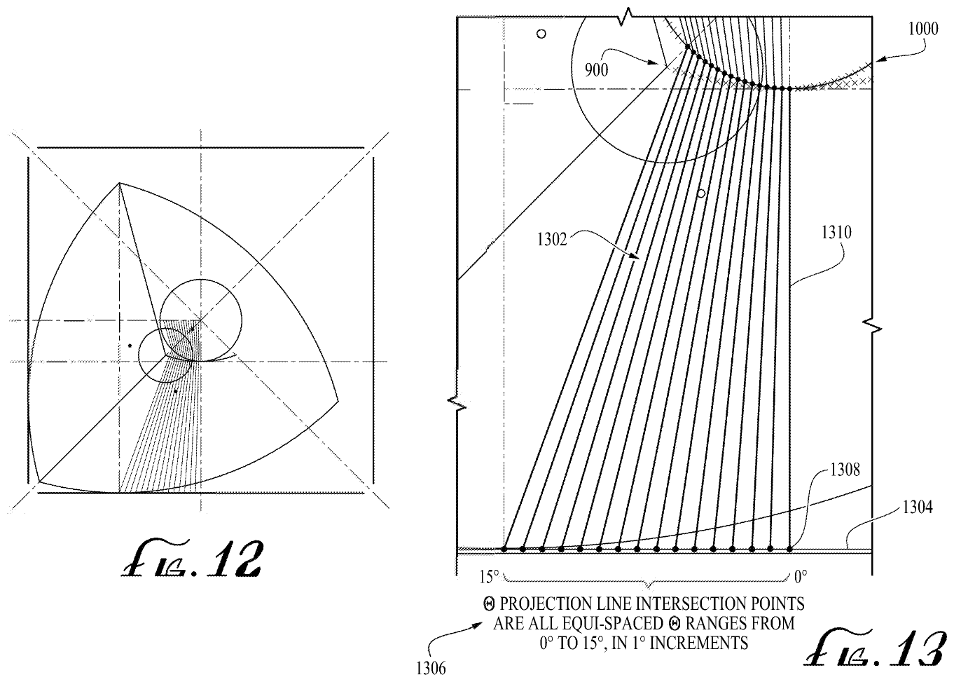

FIG. 11 shows an overview 1100 of non-circular centroid orbital path 900 and circular centroid orbital path 1000 to compare the full orbits between the original and modified paths. New circular centroid orbital path 1000 should have a new contact rolling surface design too, since the original Reuleaux triangle surface would not be able to make consistent non-scrubbing contact if it follows arcuate path 1002. FIG. 12-FIG. 17 show how a new arcuate contact surface profile can be created by initially setting the Reuleaux triangle to Θ=−15°.

FIG. 13 shows in greater detail that, in order to map a non-scrub rolling surface to the trajectory of circular centroid orbital path 1000, a set of lines 1302 are projected from each Θ location on circular centroid orbital path 1000, down to a surface 1304 being rolled onto. To ensure no scrubbing, the projection lines are equi-spaced 1306 for each common increment of Θ, starting from a tangent intersection 1308 of a vertical projection 1310.

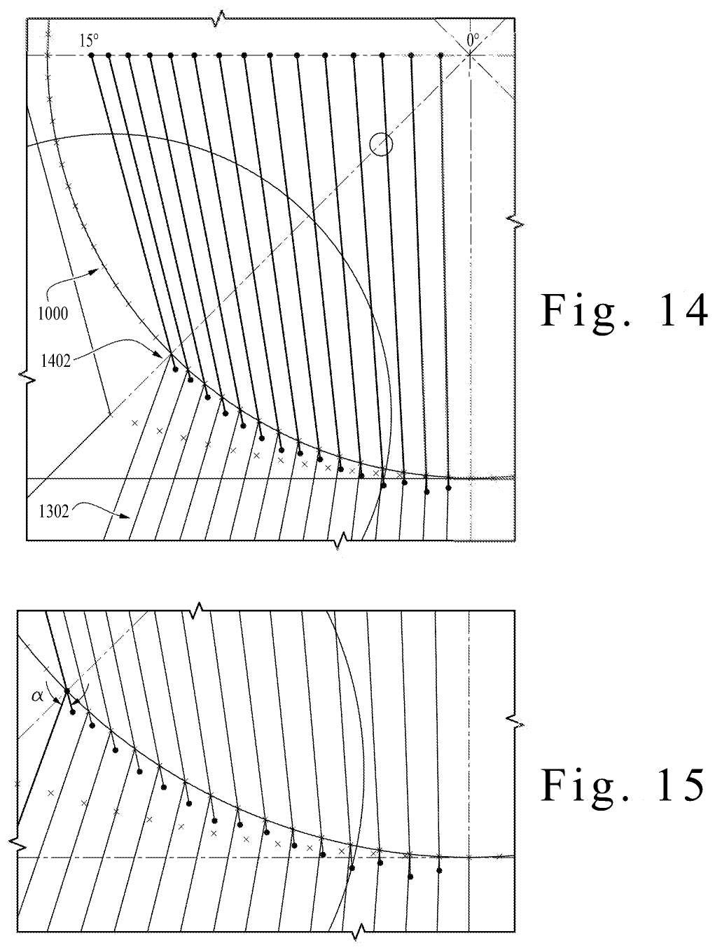

FIG. 14 shows how corresponding line intersections 1402 to Θ locations of circular centroid orbital path 1000 are created. These corresponding line intersections 1402 vary from 15° to 0° from vertical, and they correspond to the new Θ orientation.

FIG. 15 shows how an angle α is now defined. This angle corresponds to the angle between set of lines 1302 and corresponding line intersections 1402, for each Θ location. The table below can now be constructed to map angle Θ to projection line length D to projection line angle from new centroid α. Using each D and a in the table, FIG. 16 shows how a new non-scrub surface 1602 can now be constructed about a new centroid.

| Θ | D | α |
|---|---|---|
| 15 | 139.56 | 35.07 |
| 14 | 137.11 | 32.88 |
| 13 | 134.81 | 30.66 |
| 12 | 132.67 | 28.42 |
| 11 | 130.69 | 26.16 |
| 10 | 128.88 | 23.87 |
| 9 | 127.23 | 21.56 |
| 8 | 125.74 | 19.22 |
| 7 | 124.43 | 16.87 |
| 6 | 123.29 | 14.51 |
| 5 | 122.32 | 12.13 |
| 4 | 121.52 | 9.74 |
| 3 | 120.9 | 7.34 |
| 2 | 120.46 | 4.95 |
| 1 | 120.19 | 2.62 |
| 0 | 120.1 | 0 |

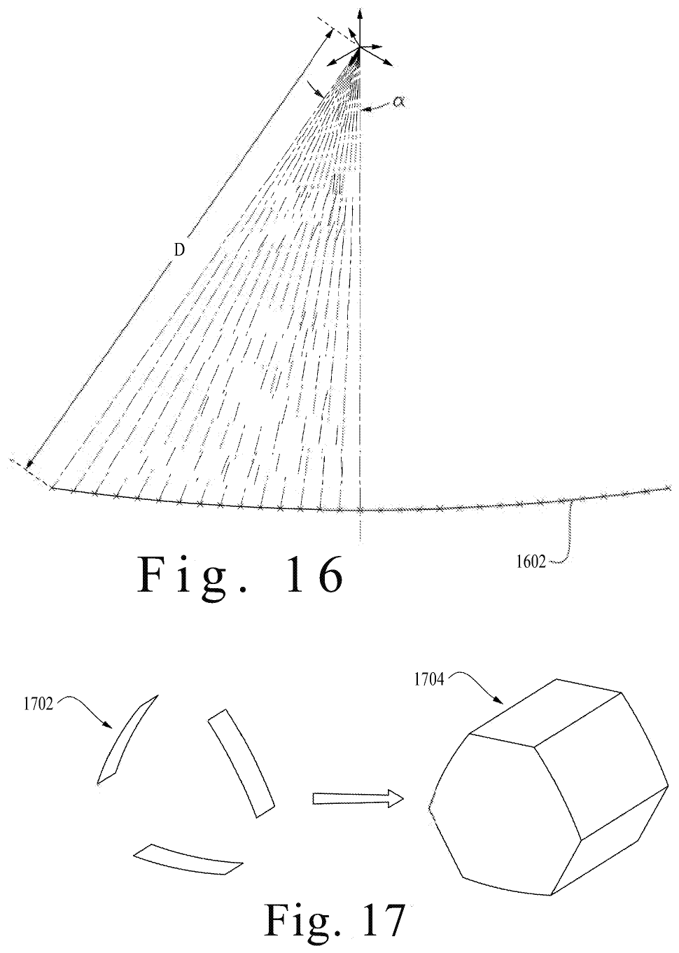

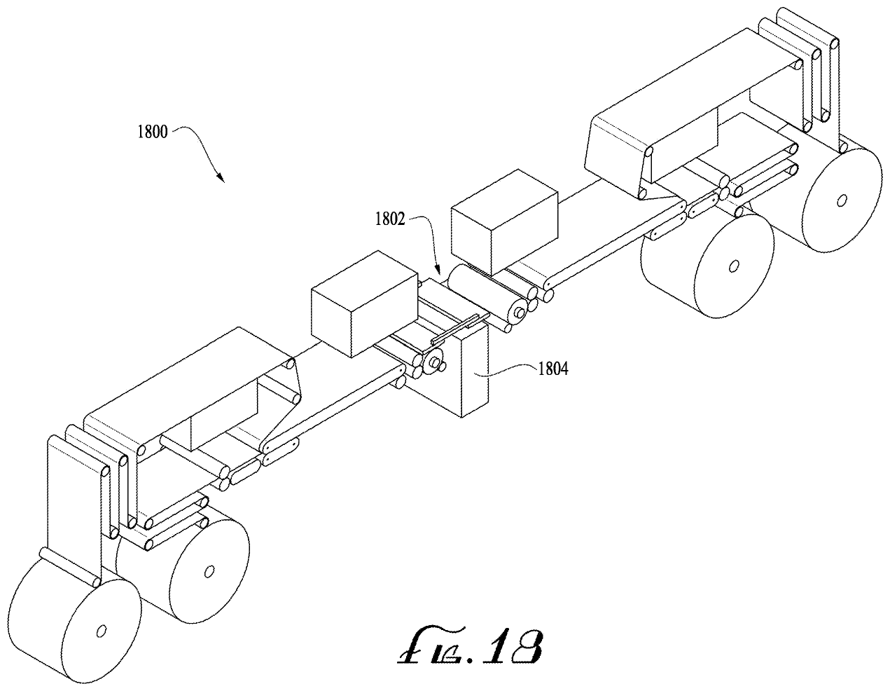

FIG. 17 shows how patterning surface 1602 on three sides that are angularly spaced apart by 120° about the centroid yields a tri-lobular shape 1702 appropriate for the prescribed orbital and centroidal rotation motions. In some embodiments, tri-lobular shape 1702 can be part of a hollow or solid body (see, e.g., body 312, FIG. 3) to yield a prism shape that orbits a circular path (i.e., amenable to geared transmission), with a non-scrub rolling surface on three exterior surfaces. In other embodiments, tri-lobular shape 1702 may have its sides connected by spokes on a hub (not shown).

In other embodiments, additional numbers of sides are also possible. Skilled persons will also appreciate that, instead of the previously described empirical approach, closed-form analytical techniques may also be employed to develop arcuate gripper surface shapes.

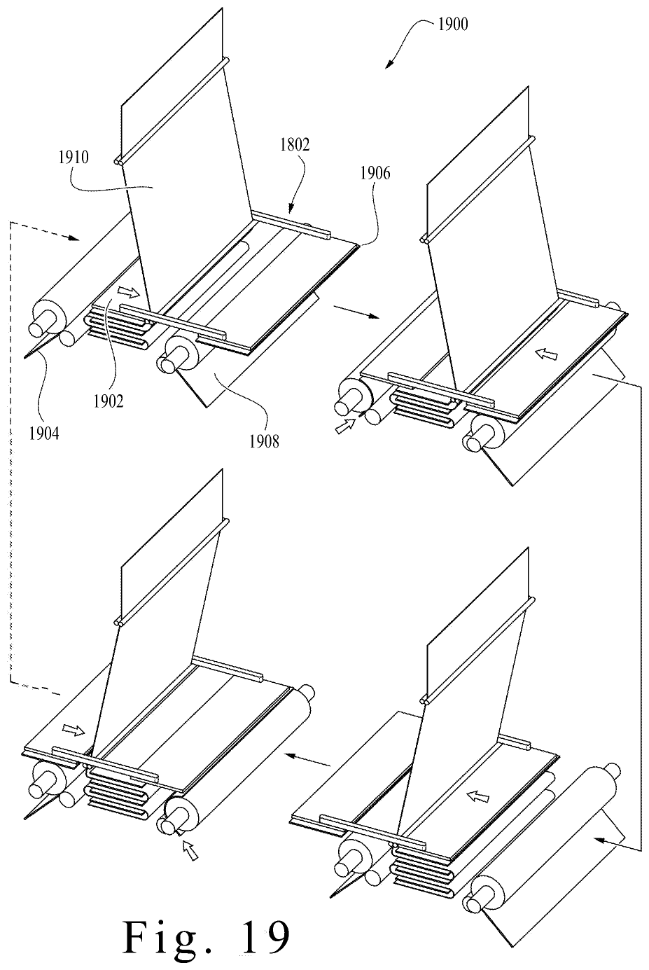

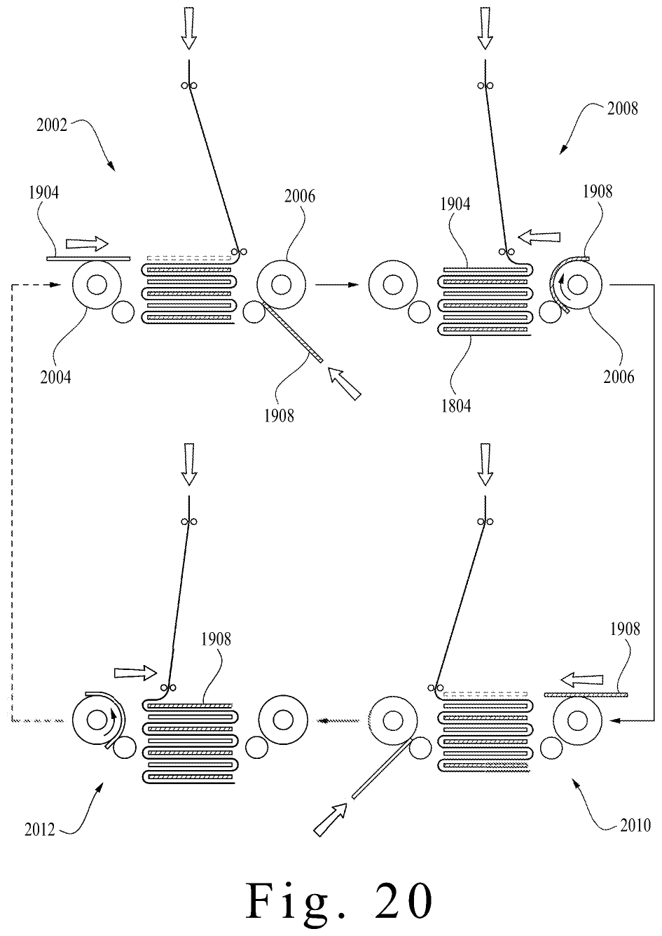

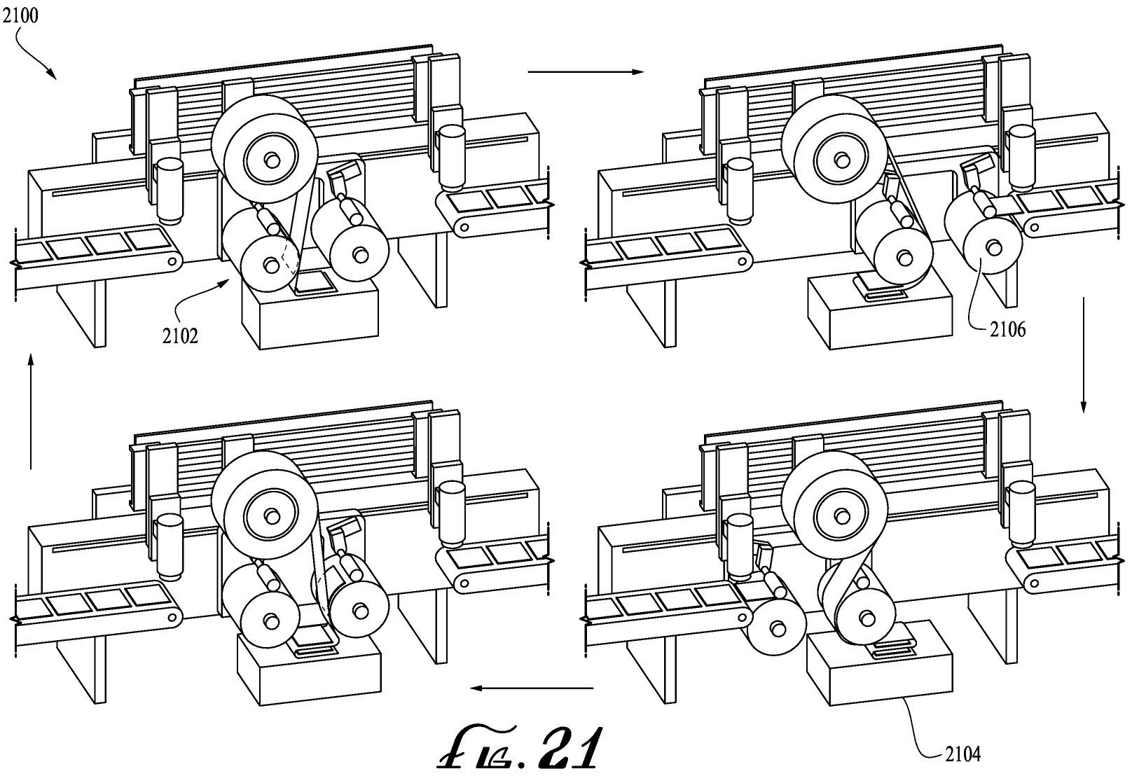

FIG. 18-FIG. 20 show another embodiment of a z-fold stacker machine 1800. In this embodiment, instead of using the prism design as described previously, a reciprocating carriage 1802 shuffles from side to side to pick up electrode layers, fold a separator (shown in FIG. 19 and FIG. 20), while placing them in a stack 1804.

FIG. 19 shows a sequence 1900 of reciprocating motion for reciprocating carriage 1802. Reciprocating carriage 1802 includes a first gripper 1902 for a first electrode 1904, a second gripper 1906 for a second electrode 1908, and a gap for z-folding a separator 1910 as reciprocating carriage 1802 moves from side to side.

FIG. 20 shows how z-fold stacker machine 1800 achieves a rolling transfer of battery layers so as to reduce scrubbing. For clarity, FIG. 20 omits reciprocating carriage 1802.

In a first position 2002, a first electrode 1904 is oriented horizontally atop a first vacuum roller 2004 where it can be lifted by a negative pressure applied by first gripper 1902 (FIG. 19). Concurrently, second electrode 1908 is introduced to a second vacuum roller 2006.

In a second position 2008, first electrode 1904 is released by first vacuum roller 2004 and shuttled atop stack 1804. Concurrently, second vacuum roller 2006 applies, via its arcuate surface, a vacuum force to second electrode 1908 to move it from its initial location and flex it into a conforming position on the arcuate surface.

A third position 2010 is then reached as follows. While the vacuum force maintains second electrode 1908 flexed in the conforming position, second vacuum roller 2006 rotates so that the arcuate surface retaining second electrode 1908 is moved into a second location (e.g., horizontal) that is transverse to the first location when second electrode 1908 was introduced.

To transition to a fourth position 2012, second vacuum roller 2006 releases its vacuum force while second gripper 1906 (FIG. 19) applies a vacuum force to provide a substantially scrub-free transfer of second electrode 1908 from the conforming position on the arcuate surface and into an unflexed position on a receiver surface of second gripper 1906 for depositing second electrode 1908 into battery electrode and separator stack 1804.

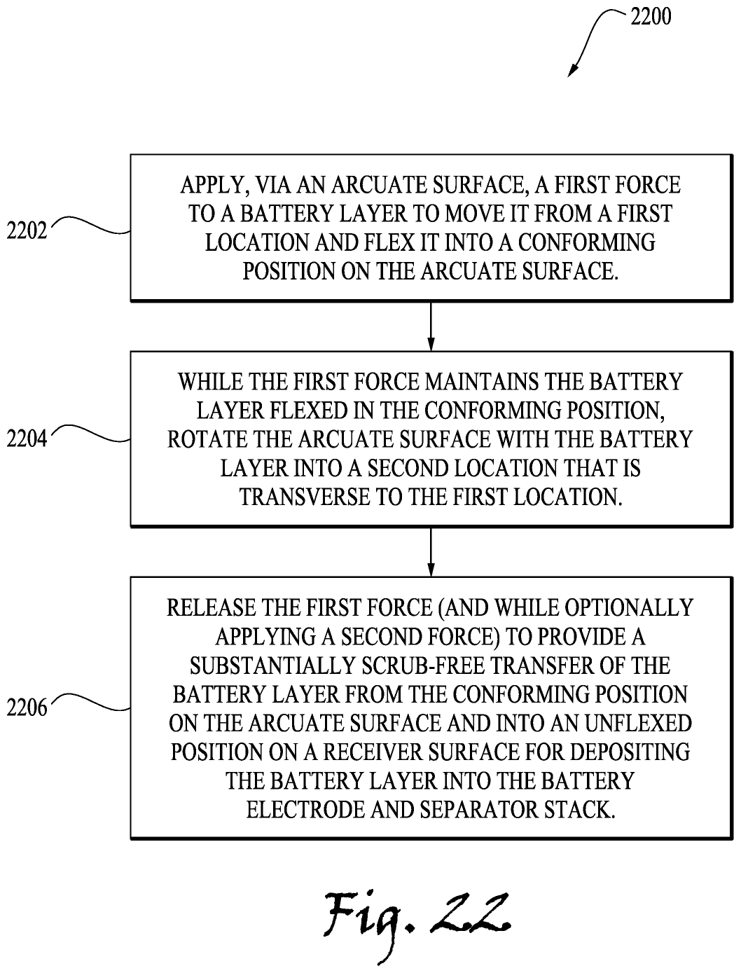

FIG. 21 shows another z-fold stacker machine 2100 including a pair of reciprocating rollers 2102 during a stacking sequence. Pair of reciprocating rollers 2102 function similar to reciprocating carriage 1802, but instead of lifting and placing electrodes, each one of reciprocating rollers 2102 rotates with a flexed electrode conforming to a roller surface (e.g., by application of vacuum force through pneumatic gripper apertures, not shown) while gradually releasing the negative pressure and applying a positive pressure as the roller moves across the top of a stack 2104. For instance, a right-side roller 2106 gathers an electrode provided at the right side, shuffles it leftward while applying a vacuum force and rotating it over stack 2104, and gradually releases the vacuum force while applying a positive pressure as a function of the lateral position over stack 2104.

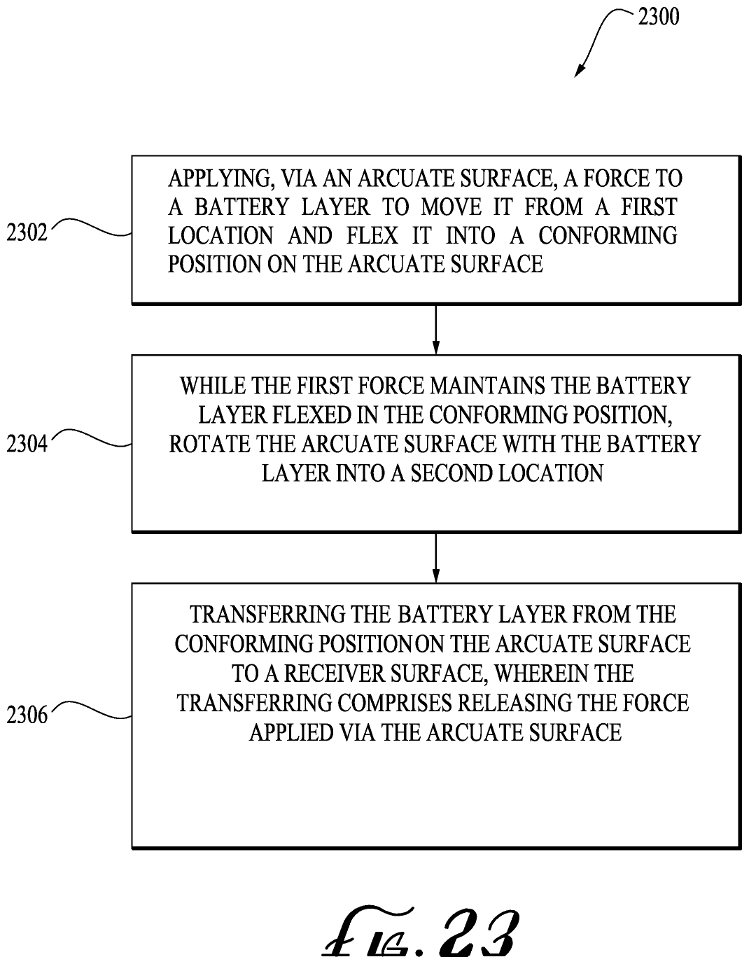

FIG. 22 shows a method 2200 (which may be performed by any one of stacker machine 100, 400, 600, 1800, or 2100 and/or a multi-sided gripper) of forming a battery electrode and separator stack. In block 2202, method 2200 applies, via an arcuate surface, a force to a battery layer to move it from a first location and flex it into a conforming position on the arcuate surface. In block 2204, while the force maintains the battery layer flexed in the conforming position, method 2200 rotates the arcuate surface with the battery layer into a second location that is transverse to the first location. In block 2206, method 2200 releases the force while optionally applying an opposite force to provide a substantially scrub-free transfer of the battery layer from the conforming position on the arcuate surface and into an unflexed position on a receiver surface for depositing the battery layer into the battery electrode and separator stack. The method may also include eccentrically rotating the arcuate surface so that it translates laterally and vertically relative to the receiver surface.

FIG. 23 shows a method 2300 (which may in some embodiments be performed a stacker machine 100, 400, 600, 1800, or 2100 and/or a multi-sided gripper) for transporting a battery layer from a first position to a second position using an arcuate surface, which may be part of forming a electrode and separator stack.

The method 2300 comprises applying 2302, via an arcuate surface, a force to a battery layer to move it from a first location and flex it into a conforming position on the arcuate surface. The applied force may in some embodiments be applied via vacuum, and in some embodiments it may be applied electrostatically. The arcuate surface may in some embodiments be located at a multi-sided gripper and/or in stacker machine.

In step 2304, while the force maintains the battery layer flexed in the conforming position, the method comprises transporting the arcuate surface with the battery layer to a receiver surface. The transporting may comprise rotating the arcuate surface, wherein the rotating may comprise eccentric rotation. The receiver surface is located at a second location different from the first location. In some embodiments, the receiver surface is angularly offset from the first location. In some embodiments the second location is transverse to the first location.

In step 2306, the method 2300 comprises transferring the battery layer from the conforming position on the arcuate surface to a receiver surface, wherein the transferring comprises releasing the force applied via the arcuate surface, and optionally applying an opposite force to provide the transfer. The transfer may in some embodiments be scrub-free or substantially scrub-free.

In some embodiments, the receiver surface is another arcuate surface. In some embodiments, the receiver surface is located on an electrode and separator stack and the transferring comprises depositing the battery layer into the battery electrode and separator stack.

The methods 2200, 2300 may also include eccentrically rotating the arcuate surface so that it translates laterally and vertically relative to the receiver surface.

In another embodiment, methods 2200, 2300 may also include applying of the force by pulling a vacuum through apertures in the arcuate surface.

In another embodiment, methods 2200, 2300 may also include the battery layer having a discrete electrode atop a continuous separator sheet.

In another embodiment, methods 2200, 2300 may also include the battery layer having a discrete electrode atop a discrete separator sheet.

In another embodiment, methods 2200, 2300 may also include applying of the force by pulling a vacuum through pores on the continuous separator sheet to flex the battery layer.

In another embodiment, methods 2200, 2300 may also include applying of the force by pulling a vacuum through apertures in a laterally reciprocating gripper.

In another embodiment, methods 2200, 2300 may also include applying of the optional force by gradually applying, as a function of lateral position, positive pressure applied through apertures in a laterally reciprocating roller.

In another embodiment, methods 2200, 2300 may also include the first location being a vertically oriented material-transfer position defined by the arcuate surface confronting another arcuate surface that acts as a pick-and-place device.

In another embodiment, methods 2200, 2300 may also include performing the applying of the force, the rotating, and the transferring and/or releasing in connection with a first laterally reciprocating roller on a first side of the battery stacker, and the method further includes repeating the applying of the force, the rotating, and the transferring and/or releasing in connection with a second laterally reciprocating roller on a second side of the battery stacker.

Skilled persons will appreciate that many changes may be made to the details of the above-described embodiments without departing from the underlying principles of the invention. For example, the embodiments may be employed for other applications including unstacking, singulation, and pick-and-place uses. The scope of the present invention should, therefore, be determined only by claims and equivalents thereof.

What is claimed is:

1. A method, performed by a battery stacker, of forming a battery electrode and separator stack, the method comprising:
applying, via an arcuate surface, a force to a battery layer to move it from a first location and flex it into a conforming position on the arcuate surface;
while the force maintains the battery layer flexed in the conforming position, rotating the arcuate surface with the battery layer into a second location; and
transferring the battery layer from the conforming position on the arcuate surface to a receiver surface by, wherein the transferring comprises releasing the force applied via the arcuate surface.

2. The method according to claim 1, wherein the receiver surface is another arcuate surface, and wherein the transferring comprises applying a force with the arcuate receiver surface to flex the layer into a conforming position on the receiver surface.

3. The method according to claim 1, wherein the receiver surface is a battery electrode and separator stack comprising a substantially planar surface, and wherein the transferring comprises transferring the battery layer to an unflexed position.

4. The method of claim 1, in which the rotating comprises eccentrically rotating the arcuate surface so that it translates laterally and vertically relative to the receiver surface.

5. The method of claim 1, in which the applying of the force comprises pulling a vacuum through apertures in the arcuate surface.

6. The method of claim 1, further comprising gradually applying, as a function of lateral position, positive pressure through apertures in a laterally reciprocating roller.

7. The method of claim 1, in which the first location is a vertically oriented material-transfer position defined by the arcuate surface confronting another arcuate surface that acts as a pick-and-place device.

8. The method of claim 1, further comprising performing the applying of the force, the rotating, and the transferring in connection with a first laterally reciprocating roller on a first side of the battery stacker, the method further comprising repeating the applying of the force, the rotating, and the transferring in connection with a second laterally reciprocating roller on a second side of the battery stacker.

9. A battery stacker, comprising:
an arcuate surface configured for application of a force for pulling a battery layer from a first location and flexing into a conforming position on the arcuate surface;
an axis about which the arcuate surface is rotatable while the force maintains the battery layer flexed in the conforming position so as to rotate the battery layer into a second location; and
a receiver surface for receiving the battery layer in response to release of the force to transfer the battery layer from the conforming position on the arcuate surface to the receiver surface.

10. The battery stacker of claim 9, wherein the receiver surface is another arcuate surface.

11. The battery stacker of claim 9, wherein the receiver surface is a battery electrode and separator stack comprising a substantially planar surface.

12. The battery stacker of claim 9, further comprising a rotatable multi-sided gripper including the arcuate surface.

13. The battery stacker of claim 9, in which the force is a vacuum force applied through apertures in the arcuate surface.

14. The battery stacker of claim 9, in which the force is a first force and in which the arcuate surface is configured for application of a second force as a positive pressure applied though apertures in the arcuate surface.

15. A rotatable multi-sided gripper for transporting a battery layer, comprising:
a body, including:
three mutually angularly spaced apart acuate gripper surfaces; and
three mutually angularly spaced apart truncated sides,
wherein each arcuate gripper surface comprises means for applying a force on a battery layer positioned on the gripper surface for maintaining the battery layer in a conforming position on the arcuate surface.

16. The rotatable multi-sided gripper according to claim 15, wherein each arcuate gripper surface further comprises means for applying a second force as a positive pressure on the battery layer in order to release and/or transfer the battery layer to a receiver surface.
